(19) United States
(12) Patent Application Publication
(10) Pub. No.: US 2018/0155502 A1
(43) Pub. Date: Jun. 7, 2018

(54) ORGANOSILICON COMPOUNDS HAVING AMINO ACID MOIETIES, AND PROCESS FOR PREPARATION THEREOF

(71) Applicant: Wacker Chemie AG, Muenchen (DE)

(72) Inventors: Elke FRITZ-LANGHALS, Ottobrunn (DE); Richard WEIDNER, Burghausen (DE)

(21) Appl. No.: 15/572,989

(22) PCT Filed: May 30, 2016
(86) PCT No.: PCT/EP2016/062104

§ 371 Date: Nov. 9, 2017

(30) Foreign Application Priority Data
Jun. 2, 2015 (DE) 10 2015 210 171.1

(51) Int. Cl. C08G 77/388; C08L 83/06; C08K 5/17; C08K 5/05

(52) U.S. Cl. CPC C08G 77/388; C08L 83/06; C08G 77/14; C08K 5/05; C08K 5/175

(57) ABSTRACT

The invention provides a process for preparing organosilicon compounds (O) which contain free amino acid moieties and contain at least one unit of the general formula (I) and no unit or at least one unit of the general formula (II), R¹_{b}(X)_{c}SiO_{[4-(b+c)]/2} (I), R²ₐSiO_{(4-a)/2} (II), in which epoxy-functional organosilicon compounds composed of at least one unit of the general formula (III) and no unit or at least one unit of the general formula (II), R¹_{b}(Z)_{c}SiO_{[4-(b+c)]/2} (III), R²ₐSiO_{(4-a)/2} (II), where Z has the definition (formula A), are reacted with unprotected amino acids of the general formula (IV): H—NR⁷—(CH₂)_{f}—CR⁸R⁹—COOH, in the presence of aliphatic alcohols, where R¹, R², R⁴, R⁵, R⁶, R⁷, R⁸, R⁹, X, Z, Y, a, b, c, e and f have the definitions given in claim 1, the organosilicon compounds (O) which contain free amino acid moieties and are prepayable by the process, and uses for the organosilicon compounds (O).

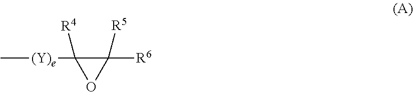

The invention relates to amino acid moiety-containing organosilicon compounds and to a simple process for the production thereof and to the use thereof.

Amino group-containing organosilicon compounds play an important role in industry. The presence of the polar amino group in a polysiloxane significantly increases the interaction with polar surfaces and thus the adhesiveness of the polysiloxane for example. This gives rise to a multitude of possible industrial applications, for example in the field of textiles finishing or in cosmetics. In this connection amino acid-functionalized organosilicon compounds are industrially very interesting because the additional presence of the carboxylic acid moiety can achieve a still higher polarity. Amino acid moieties are generally present in the betaine structure as a result of which electrostatic interactions are much more strongly pronounced than in the amino group-containing organosilicon compounds. A further positive aspect is that the production thereof can utilize the broad and also cost-effective feedstock base of the industrially available amino acids. The very predominant portion of the amino acids is generated from renewable feedstocks and the product class of amino acid moiety-containing organosilicon compounds therefore also offers advantages from the aspect of sustainability.

Various processes for preparing amino acid-functionalized polysiloxanes are already known. However, it is amino acid-functional organosilicon compounds where the basic character of the amino moiety and consequently also the amphoteric character of the amino acid moiety is retained after linking with the polysiloxane that are primarily of interest. This is the case particularly for the linking of the amino acid with the polysiloxane by addition onto a reactive epoxide moiety on the polysiloxane.

DE 10036532, JP 52-114699, EP 2826806 and EP 2231752 describe various processes based on this reaction type.

However, a process for producing the free amino acid moiety-containing compounds has not hitherto existed.

DE 10036532 discloses a process for preparing polysiloxanes functionalized in the α,ω-position with amino acid units, wherein epoxy group-bearing polysiloxanes are reacted with amino acid derivatives where the carboxylic acid moiety is present in protected form as a salt or in the form of an ester.

However, in most cases only the free amino acids are available cost-effectively and on a large industrial scale and conversion into the salts or into the esters therefore requires an additional reaction step which makes the synthesis inconvenient and costly.

JP 52-114699 likewise describes the reaction of amino acids protected at the carboxyl group using an epoxy-functional trisiloxane.

EP 2826806 describes the production of amino acid-modified siloxanes from organic amino acid salts, wherein an organic cation, for example a quaternary ammonium or phosphonium cation having a long-chain alkyl radical, is present as the counterion to the carboxylate ion of the amino acid. The production of these amino acid salts already requires two reaction steps: in a first step the amino acids are converted into the potassium salts, in a second step the reaction with the quaternary ammonium or phosphonium chloride to form potassium chloride, which may be precipitated by dispersion in a suitable medium and removed, is effected. This process is therefore both inconvenient and costly.

In addition, quaternary ammonium and phosphonium compounds are considered toxicologically questionable and the possible application spectrum of the compounds is therefore reduced.

A process where the industrially available free amino acids could be employed directly without prior conversion into salts would therefore be of great advantage. This would also make available amino acid-functional organosilicon compounds which contain unprotected carboxyl groups and thus show more pronounced properties of an amino acid moiety.

EP 2231753 describes the reaction of epoxy-functional polysiloxanes having free amino acids in an aqueous emulsion in the presence of approximately 25 to 28 weight % of emulsifier. The commixing of the usually extremely viscous emulsions is a great technical challenge for the employed stirrer systems which must be operated with high power outputs, thus resulting in elevated energy costs.

In this process the formed amino acid group-bearing siloxane is always generated in admixture with emulsifiers which on account of their similar properties to the product cannot be removed. The amino acid-functionalized organosilicon compounds therefore cannot be isolated in pure form according to this teaching. This markedly limits the field of application of the amino acid-functional polysiloxanes. The emulsifier proportions may have disruptive or even prohibitive effects during the further use.

The invention relates to a process for producing free amino acid moiety-containing organosilicon compounds (O) containing at least one unit of general formula I and no unit or at least one unit of general formula II

R¹_{b}(X)_{c}SiO_{[4-(b+c)]/2} (I),

R²ₐSiO_{(4-a)/2} (II),

wherein epoxy-functional organosilicon compounds composed of at least one unit of general formula III and no unit or at least one unit of general formula II

R¹_{b}(Z)_{c}SiO_{[4-(b+c)]/2} (III),

R²ₐSiO_{(4-a)/2} (III),

wherein Z represents

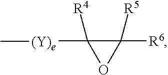

are reacted with unprotected amino acids of general formula IV

H—NR⁷—(CH₂)_{f}—CR⁸R⁹—COOH, (IV)

in the presence of aliphatic alcohols,
wherein
R¹ and R² independently of one another represent hydrogen or an unbranched, branched or cyclic saturated or unsaturated alkyl group or alkoxy group having 1 to 20 carbon atoms or aryl group or aralkyl group, wherein individual nonadjacent methylene units may be replaced by —O—, —CO—, —COO—, —OCO— or —OCOO—, —S— or NR^{x} groups or by an oxyalkylene group of general formula (—O—CH₂—CHR³—)_{d} where d is from 1 to 100, wherein the radicals R³ can represent hydrogen or alkyl,
R^{x} represents hydrogen or a C₁-C₁₀-hydrocarbon radical which is unsubstituted or substituted with substituents selected from —CN and halogen,
X represents a radical of general formula V bearing at least one amino acid unit and bonded to the organosilicon compound via a carbon atom

(Y)ₑ—CR⁴(OH)—CR⁵R⁶—NR⁷—(CH²)_{f}—CR⁸R⁹—COOH, (V)
Y represents a linear, branched, cyclic, saturated or mono- or polyunsaturated C₁ to C₁₀₀ alkylene radical bonded to the organosilicon compound via a carbon atom, wherein individual carbon atoms may be replaced by oxygen, nitrogen or sulfur atoms,
R⁴, R⁵ and R⁶ independently of one another represent hydrogen or a linear, branched or cyclic saturated or unsaturated C₁ to C₂₀ alkyl group, wherein individual nonadjacent methylene units may be replaced by —O—, —CO—, —COO—, —OCO— or —OCOO—, —S— or NR^{x} groups,
R⁷ represents hydrogen or a linear, branched or cyclic saturated or unsaturated alkyl group having 1 to 20 carbon atoms or aryl group or aralkyl group, wherein individual nonadjacent methylene units may be replaced by —O—, —CO—, —COO—, —OCO— or —OCOOO—, —S— or NR^{x} groups or by an oxyalkylene group of general formula (—O—CH₂—CHR³—)_{d} where d is from 1 to 100, wherein the radicals R³ independently of one another represent hydrogen or alkyl,
R⁸ and R⁹ independently of one another represent hydrogen or linear, branched or cyclic saturated or unsaturated alkyl groups having 1 to 20 carbon atoms or aryl groups or aralkyl groups, wherein individual nonadjacent methylene units may be replaced by —O—, —CO—, —COO—, —OCO— or —OCOO—, —S— or NR^{x} groups,
   wherein R⁷ may be bonded to R⁸ or to R⁹,
a takes values of 0, 1, 2 or 3,
b takes values of 0, 1, or 2,
c takes values of 1, 2, or 3,
b+c takes values of 1, 2, 3 or 4,
e takes values of 0 or 1 and
f takes integer values from 0 to 50.

It has been found that, surprisingly, epoxy moiety-bearing organosilicon compounds may be reacted with the unprotected amino acids in the presence of alcohols to afford the desired amino acid-functional organosilicon compounds (O). The production process is thus simplified. The process according to the invention additionally does not require any emulsifier addition and accordingly amino acid moiety-containing organosilicon compounds (O) not containing any emulsifiers as impurities are producible.

It is preferable when R¹ and R² represent hydrogen or an unbranched, branched or cyclic saturated or unsaturated alkyl group having 1 to 6 carbon atoms or a benzyl or phenyl group, wherein nonadjacent methylene units may be replaced by nitrogen atoms or oxygen atoms or may be replaced by an oxyalkylene group of general formula (—O—CH₂—CHR³—)_{d} where d is from 1 to 100, in particular 1 to 50, wherein the radicals R³ represent hydrogen or methyl. Particularly preferred radicals R¹ and R² are the radicals methyl, ethyl, vinyl.

It is preferable when R^{x} represents hydrogen or an unbranched, branched or cyclic saturated alkyl group having 1 to 6 carbon atoms or a benzyl or phenyl group. Particularly preferred radicals R^{x} are hydrogen and the radicals methyl, ethyl, propyl, butyl.

It is preferable when Y is a linear or branched saturated C₃ to C₂₀ alkylene radical, wherein individual carbon atoms may be replaced by oxygen, nitrogen or sulfur atoms.

In a further particularly preferred embodiment Y is an oxyalkylene radical of general formula —CH₂—CH₂—CH₂—O—(CH₂—CHR³—O)_{g}—CH₂, wherein the radicals R³ independently of one another represent hydrogen or alkyl, in particular methyl, and g takes a value of 0 to 100, preferably 0 to 15 and particularly preferably 0.

It is preferable when the radicals R⁴, R⁵ and R⁶ independently of one another represent hydrogen or a linear C₁ to C₆ alkyl group, particularly preferably hydrogen or linear C₁ to C₃ alkyl group, in particular the radicals methyl, ethyl or propyl.

The radicals R⁵ and R⁶ may also be bonded to one another and to the moiety Y via alkylene radicals, in particular C₁ to C₆ alkylene radicals or oxygen.

R⁷ preferably represents hydrogen or a linear, branched or cyclic saturated or unsaturated alkyl group having 1 to 10 carbon atoms or a benyl or phenyl group, wherein nonadjacent methylene units may be replaced by nitrogen atoms or oxygen atoms or may be replaced by an oxyalkylene group of general formula (—O—CH₂—CHR³—)_{d} where d is from 1 to 100, wherein the radicals R³ independently of one another represent hydrogen or methyl. R⁷ particularly preferably represents a C₁-C₆ alkyl group, wherein methylene units may be replaced by oxyalkylene groups of general formula —O—(CH₂—CHR³—)_{d} where d is from 1 to 50, wherein the radicals R³ independently of one another represent hydrogen or methyl. Particularly preferred radicals R⁷ are the radicals methyl, ethyl, propyl, butyl.

It is preferable when R⁸ represents hydrogen and R⁹ represents hydrogen or a linear, branched or cyclic saturated or unsaturated alkyl group having 1 to 10 carbon atoms or aryl group or aralkyl group, wherein individual nonadjacent methylene units may be replaced by —O—, —CO—, —COO—, —OCO— or —OCOO—, —S— or NR^{x} groups, in particular —CH₃, —CH(CH₃)₂, —CH₂—CH(CH₃)₂, —CH(CH₃)—CH₂—CH₃, —CH₂—OH, —CH₂—CH₂—OH, —CHOH—CH₃, —CH₂—SH, —CH₂—S—S—CH₂—CH(NH₂) COOH, —CH₂—CH₂—S—CH₃, —CH₂—CH₂—CONH₂, —CH₂—CONH₂, CH₂—CH₂—COOH, CH₂—COOH, —CH₂—CH₂—CH₂—NH—CO—NH₂, —CH₂— phenyl, —CH₂-(4-hydroxyphenyl), —CH₂—CH₂—CH₂—CH₂—NH₂, —CH₂—CH₂—CH₂—NH₂, —CH₂—CH₂—CH₂—NH—C(═NH)—NH₂, and —CH₂-(4-imidazolyl), —CH₂-(3-indolyl).

f preferably has integer values of 0 to 10, particularly preferably 0 to 5 and very particularly preferably values of 0, 1, 2 or 3.

Examples of epoxide unit-bearing Si-bonded moieties Z are:

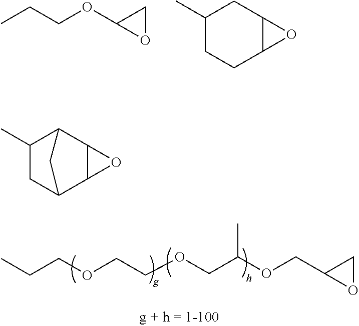

The epoxy group-bearing organosilicon compounds—as is known to those skilled in the art—may be produced for example by addition of Si—H moieties onto olefinic group-bearing epoxides, for example allyl glycidyl ethers or cyclohexadiene monoepoxides or by epoxidation of olefinic moiety-bearing organosilicon compounds or by dehydrohalogenation of chlorohydrins.

For the amino acids R⁷ may also be bonded to R⁸ or to R⁹; it is preferable when the radicals are bonded via an alkyl radical, an example thereof is the amino acid proline.

Preferred examples of amino acids are:

Glycine, sarcosine, alanine, β-alanine, valine, leucine, isoleucine, γ-aminobutyric acid,

serine, homoserine, threonine,

cysteine, cystine, methionine,

glutamine, asparagine, proline

phenylalanine, tyrosine,

glutamic acid, aspartic acid, citrulline,

lysine, ornithine, arginine, histidine and tryptophan.

For amino acids having more than one carboxyl group the further carboxyl groups may independently of one another be present as free carboxyl groups or as salts, preferably metal or ammonium salts, particularly preferably as alkali metal salts, alkaline earth metal salts and tertiary amines, very particularly preferably as sodium or potassium salts, or in the form of their esters, preferably alkyl esters, particularly preferably as methyl esters or ethyl esters.

The bonding of the amino acid onto the epoxy moiety-containing organosilicon compound is effected by the epoxide ring-opening addition of the moiety NHR⁷ of the amino acid of general formula IV onto the epoxide ring. When R⁷ represents hydrogen the thus formed product may react with a further epoxide moiety in the same way. Accordingly, products having one siloxane radical and products having two siloxane radicals per amino acid molecule may be formed.

Amino acids having further basic nitrogen-containing moieties, for example lysine, ornithine, arginine, histidine and tryptophan may via these moieties each react once or twice with the epoxide radical of the organosilicon compound. Not more than one organosilicon radical per hydrogen atom may be bonded to a basic nitrogen moiety of the amino acid of general formula IV.

When more than one basic nitrogen moiety is present in the employed amino acid of general formula IV, regioisomeric products are generally formed.

For example the reaction of the amino acid lysine forms the regioisomeric moieties depicted below, wherein S represents the organosilicon radical bonded via the respective spacer moiety:
upon reaction with one epoxide moiety:

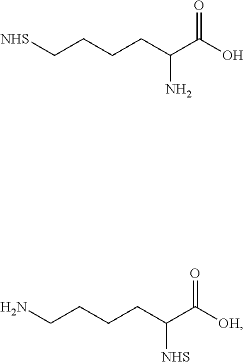

upon reaction with two epoxide moieties:

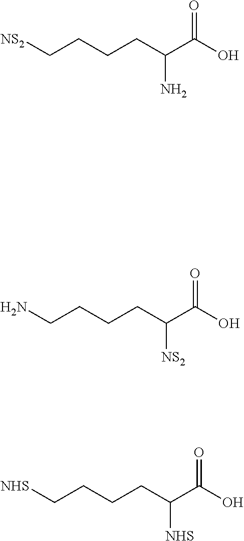

upon reaction with three epoxide moieties:

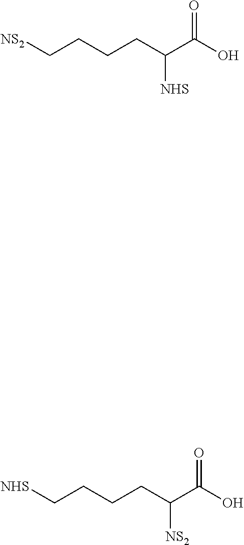

upon reaction with four epoxide moieties:

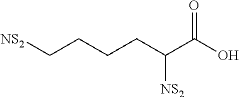

The molar ratio of organosilicon compound to amino acid radical may be influenced by the molar ratio of present epoxide moieties to amino moieties of the amino acid. If for example a deficiency of the amino acid is employed a multiple reaction with the epoxide moieties takes place with preference.

If the organosilicon compound contains more than one epoxide moiety the described multiple reaction of the amino group may result in a coupling of molecules of the organosilicon compound. If for example a deficiency of the amino acid is employed the coupling of molecules of the organosilicon compound takes place with preference. When using a molar excess of amino acid the coupling of the organosilicon radicals is repressed.

It is preferable when in the process per mole of epoxide unit present not less than 0.01 mol and not more than 50 mol of the amino acid of general formula III is employed, preferably not less than 0.1 mol and not more than 20 mol, particularly preferably not less than 0.4 mol and not more than 10 mol.

The process according to the invention may employ any desired optical isomers of the amino acids. It is likewise possible to employ mixtures of amino acids.

The reaction is performed in the presence of one or more aliphatic alcohols, preferably of general formula R¹⁰—OH. It is preferable when R¹⁰ is a linear or branched alkyl group having 1 to 20 carbon atoms, wherein nonadjacent carbon atoms may be replaced by oxygens. It is particularly preferable when R¹⁰ is a linear or branched alkyl group having 1 to 5 carbon atoms, wherein preferably 1 to 2 carbon atoms may be replaced by oxygens. Particular preference is given to alkyl groups having 1 to 5 carbon atoms, wherein particularly preferably 1 carbon atom is replaced by oxygen. Examples of alcohols are methanol, ethanol, n-propanol, iso-propanol, n-butanol, iso-butanol, tert-butanol, tert-amyl alcohol, benzyl alcohol, ethylene glycol, propylene glycol, 2-methoxyethanol, 2-methoxypropanol, 2-ethoxyethanol and glycerol, polyethylene glycol or polypropylene glycol or cocondensates of polyethylene glycol and polypropylene glycol.

Aliphatic alcohol is preferably employed in proportions of not less than 1 wt % and not more than 10000 wt %, particularly preferably in proportions of not less than 10 wt % and not more than 5000 wt % and very particularly preferably in proportions of not less than 50 wt % and not more than 1000 wt % based on the mass of the employed epoxide-functionalized organosilicon compound.

The reaction mixture may moreover contain water, preferably not less than 0.1 wt % and not more than 1000 wt %, particularly preferably in proportions of not less than 1 wt % and not more than 500 wt % and very particularly preferably in proportions of not less than 5 wt % and not more than 1000 wt % based on the mass of the employed epoxide-functionalized organosilicon compound.

The reaction may be performed in batch mode or in semi-batch mode or in continuous fashion.

It is preferably when one of the two reaction partners, preferably the amino acid, is initially charged in alcohol and subsequently the epoxide-functional organosilicon compound is added.

The reaction times are preferably not less than 1 min to not more than 100 hours, particularly preferably not less than 30 min to not more than 20 hours and very particularly preferably not less than 1 hour to not more than 10 hours.

The reaction is preferably performed at temperatures of not less than 0° C. and not more than 200° C., preferably not less than 20° C. and not more than 140° C. and particularly preferably not less than 40° C. and not more than 100° C.

The reaction is performed at a pressure between not less than 0.1 mbar to not more than 50 bar, preferably not less than 100 mbar to not more than 20 bar, particularly preferably at not less than 0.9 bar to 10 bar.

The reaction may employ further components, for example solvents, in amounts of not less than 1% and not more than 500%, preferably not less than 10% and not more than 200%, based on the overall reaction mass. Examples of solvents are linear or cyclic, saturated or unsaturated hydrocarbons, for example pentane, cyclohexane, toluene, ethers such as methyl-tert-butylether, tetrahydrofuran or dioxane, halohydrocarbons, such as dichloromethane, 1,2-dichloroethane or chlorbenzene, or so-called dipolar aprotic solvents such as acetonitrile, dimethyl sulfoxide or dimethylformamide.

Organosilicon compounds (O) obtained by the reaction may be isolated from the crude product by removal of the alcohol and of any solvent. The removal is preferably effected by distillation. Further purification steps may follow if required. For example, unreacted amino acid may be removed by washing of the crude product with water or by liquid-liquid extraction. It is for example also possible to remove the unconverted amino acid from the crude product as a solid by addition of a solvent in which the amino acid is poorly soluble, for example methyl-tert-butyl ether or alcohol or mixtures thereof.

The present invention further relates to the free amino acid moiety-containing organosilicon compounds (O) producible by the abovementioned process.

Since no emulsifier addition is required for production of the free amino acid moiety-containing organosilicon compounds (O), the organosilicon compounds (O) are blended with not more than 15 weight percent, preferably not more than 5 weight percent, particularly preferably not more than 2 weight percent, especially preferably not more than 1 weight percent of an emulsifier. In a preferred embodiment the organosilicon compounds (O) are not blended with any emulsifier.

All abovementioned symbols of the abovementioned formulae are each defined independently of one another. The silicon atom is tetravalent in all formulae.

The invention further relates to the use of the free amino acid moiety-containing organosilicon compounds (O). The softening and in some cases water-repellent properties of the siloxane component on the one hand and the polar betaine structure on the other hand, which have a decisive influence on the absorption behavior of the compounds according to the invention, may be employed in cosmetic formulations for skincare and haircare, in polishes for the treatment and finishing of surfaces, for finishing of textiles and textile fibers or as softeners during or after the washing process.

In the examples which follow, unless otherwise stated in each case, all amounts and percentages reported are based on weight and all temperatures are 20° C.

### EXAMPLE 1 (Copolymer n=9)

10 g (68.4 mmol) of lysine were dissolved in 200 g of methanol at reflux temperature and then over a period of 5 hours admixed with 50.0 g of α,ω-glycidoxypropyl-functionalized polysiloxane (MW˜890, about 112 mmol of epoxide groups). NMR-spectroscopic analysis showed that small proportions of unconverted epoxide moieties were present. A further 3.2 g (21.9 mmol) of lysine were therefore added and heated under reflux for a further 5 hours. The reaction batch was concentrated by evaporation and to remove excess lysine washed with water and dried under vacuum. 54.2 g of product having a plastic to glassy consistency were obtained. NMR-spectroscopic analysis indicated quantitative conversion of the epoxide groups and covalent bonding of lysene.

### EXAMPLE 2 (α,ω, n=54)

16.6 g (113 mmol) of lysine were dissolved in 800 ml of ethanol and the mixture was heated to 78° C. At this temperature 41.0 g of α,ω-glycidoxypropyl-functionalized polysiloxane (MW˜4300, about 9.45 mmol of epoxide groups) were added over 4 hours and the reaction temperature was held at 78° C. for a further 4 hours. NMR-analysis determined complete conversion of all epoxide groups present. Ethanol was distilled off under vacuum and the residue was washed with water to remove lysine. After drying 44 g of amino acid-functional polysiloxane having a honey-like consistency were obtained. NMR-spectroscopic analysis indicated quantitative conversion of the epoxide groups and covalent bonding of lysene.

### EXAMPLE 3 (Macromer n=17)

32.0 g (219 mmol) of lysine were dissolved in 314 g of methanol at 65° C. and then admixed with 50.0 g (36.5 mmol) of α-glycidoxypropyl-ω-n-butyl-functionalized linear polydimethylsiloxane (chain length about 17 Si—O units). The mixture was allowed to boil under reflux for 20 hours and then cooled to room temperature. Methanol was removed under vacuum on a rotary evaporator. The residue was washed with water and dried. The product is obtained as a viscous oil. NMR-spectroscopic analysis indicated quantitative conversion of the epoxide groups and covalent bonding of lysene.

### EXAMPLE 4 (Macromer n=100)

5.85 g (40.0 mmol) of lysine were dissolved in 325 g of ethanol at reflux temperature and then admixed with 50.0 g (6.66 mmol) of α-glycidoxypropyl-ω-n-butyl-functionalized linear polydimethylsiloxane (chain length about 100 Si—O units). The mixture was allowed to boil under reflux for 20 hours and then cooled to room temperature. Two liquid phases were formed. The upper phase was removed, the lower phase was concentrated by evaporation on a rotary evaporator and dispersed in MTBE. The insoluble constituents (unconverted lysine) were decanted off and the MTBE phase was concentrated by evaporation. The product was obtained as a viscous oil. NMR-spectroscopic analysis indicated quantitative conversion of the epoxide groups and covalent bonding of lysene.

1. A process for producing free amino acid moiety-containing organosilicon compounds containing at least one unit of general formula I and no unit or at least one unit of general formula II
R¹_{b}(X)_{c}SiO_{[4-(b+c)]/2} (I),
R²ₐSiO_{(4-a)/2} (II),
wherein epoxy-functional organosilicon comprising at least one unit of general formula III and no unit or at least one unit of general formula II
R¹_{b}(Z)_{c}SiO_{[4-(b+c)]/2} (III),
R²ₐSiO_{(4-a)/2} (III),
wherein Z represents 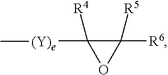
are reacted with unprotected amino acids of general formula IV
H—NR⁷—(CH₂)_{f}—CR⁸R⁹—COOH, (IV)
in the presence of aliphatic alcohols,
wherein
R¹ and R² independently of one another represent hydrogen or an unbranched, branched or cyclic saturated or unsaturated alkyl group or alkoxy group having 1 to 20 carbon atoms or aryl group or aralkyl group, wherein individual nonadjacent methylene units are optionally replaced by —O—, —CO—, —COO—, —OCO— or —OCOO—, —S— or NR^{x} groups or by an oxyalkylene group of general formula (—O—CH₂—CHR³—)_{d} where d is from 1 to 100, wherein the radicals R³ can represent hydrogen or alkyl,
R^{x} represents hydrogen or a C₁-C₁₀-hydrocarbon radical which is unsubstituted or substituted with substituents selected from —CN and halogen,
X represents a radical of general formula V bearing at least one amino acid unit and bonded to the organosilicon compounds via a carbon atom
—(Y)_{c}—CR⁴(OH)—CR⁵R⁶—NR⁷—(CH₂)_{f}—CR⁸R⁹—COOH, (V)
Y represents a linear, branched, cyclic, saturated or mono- or polyunsaturated C₁ to C₁₀₀ alkylene radical bonded to the organosilicon compounds via a carbon atom, wherein individual carbon atoms are optionally replaced by oxygen, nitrogen or sulfur atoms,
R⁴, R⁵ and R⁶ independently of one another represent hydrogen or a linear, branched or cyclic saturated or unsaturated C₁ to C₂₀ alkyl group, wherein individual nonadjacent methylene units are optionally replaced by —O—, —CO—, —COO—, —OCO— or —OCOO—, —S— or NR^{x} groups,
R⁷ represents hydrogen or a linear, branched or cyclic saturated or unsaturated alkyl group having 1 to 20 carbon atoms or aryl group or aralkyl group, wherein individual nonadjacent methylene units are optionally replaced by —O—, —CO—, —COO—, —OCO— or —OCOO—, —S— or NR^{x} groups or by an oxyalkylene group of general formula (—O—CH₂—CHR³—)_{d} where d is from 1 to 100, wherein the radicals R³ independently of one another represent hydrogen or alkyl,
R⁸ and R⁹ independently of one another represent hydrogen or linear, branched or cyclic saturated or unsaturated alkyl groups having 1 to 20 carbon atoms or aryl groups or aralkyl groups, wherein individual nonadjacent methylene units are optionally replaced by —O—, —CO—, —COO—, —OCO— or —OCOO—, —S— or NR^{x} groups,
wherein R⁷ is optionally bonded to R⁸ or to R⁹,
a takes values of 0, 1, 2 or 3,
b takes values of 0, 1, or 2,
c takes values of 1, 2, or 3,
b+c takes values of 1, 2, 3 or 4,
e takes values of 0 or 1 and
f takes integer values from 0 to 50.

2. The process as claimed in claim 1, wherein aliphatic alcohols of general formula R¹⁰—OH are employed, wherein R¹⁰ represents a linear or branched alkyl group having 1 to 20 carbon atoms, wherein nonadjacent carbon atoms are optionally replaced by oxygens.

3. The process as claimed in claim 1, wherein Z is selected from the formulae 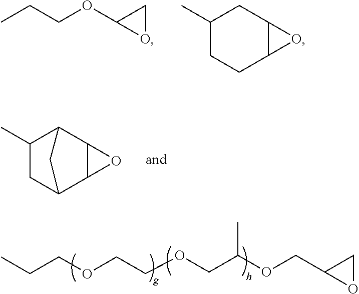
where g+h=1-100.

4. The process as claimed in claim 1, wherein R⁷ represents hydrogen or a linear, branched or cyclic saturated or unsaturated alkyl group having 1 to 10 carbon atoms or a benzyl or phenyl group.

5. The process as claimed in claim 1, wherein R⁸ and R⁹ are each independently selected from the group consisting of —CH₃, —CH(CH₃)₂, —CH₂—CH(CH₃)₂, —CH(CH₃)—CH₂—CH₃, —CH₂—OH, —CH₂—CH₂—OH, —CHOH—CH₃, —CH₂—SH, —CH₂—S—S—CH₂—CH(NH₂)COOH, —CH₂—CH₂—S—CH₃, —CH₂—CH₂—CONH₂, —CH₂—CONH₂, CH₂—CH₂—COOH, CH₂—COOH, —CH₂—CH₂—CH₂—NH—CO—NH₂, —CH₂-phenyl, —CH₂-(4-hydroxyphenyl), —CH₂—CH₂—CH₂—CH₂—NH₂, —CH₂—CH₂—CH₂—NH₂, —CH₂—CH₂—CH₂—NH—C(NH)—NH₂, —CH₂-(4-imidazolyl) and —CH₂-(3-indolyl).

6. The process as claimed in claim 1, wherein R¹ and R² are selected from the group consisting of hydrogen, methyl, ethyl and vinyl.

7. The process as claimed in claim 1, wherein the aliphatic alcohol is employed in proportions of 10 wt % to 5000 wt % based on a mass of the epoxy-function organosilicon compounds.

8. A free amino acid moiety-containing organosilicon compound producible by the process as claimed in claim 1.

9. A composition comprising the free amino acid moiety-containing organosilicon compound as claimed in claim 8 which is blended with not more than 15 weight percent of an emulsifier.

10. A composition comprising the free amino acid moiety-containing organosilicon compound as claimed in claim 8 wherein the composition is a cosmetic formulations for skincare and haircare, a polish for treatment and finishing of surfaces, for finishing of textiles and textile fibers or as a softener during or after a washing process.

11. The process as claimed in claim 2, wherein Z is selected from the formulae 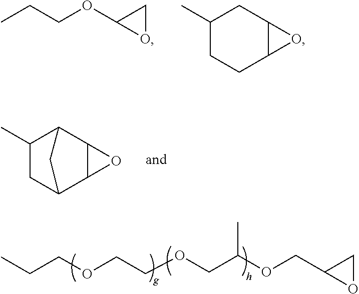
where g+h=1-100.

12. The process as claimed in claim 11, wherein R⁷ represents hydrogen or a linear, branched or cyclic saturated or unsaturated alkyl group having 1 to 10 carbon atoms or a benzyl or phenyl group.

13. The process as claimed in claim 12, wherein R⁸ and R⁹ are each independently selected from the group consisting of —CH₃, —CH(CH₃)₂, —CH₂—CH(CH₃)₂, —CH(CH₃)—CH₂—CH₃, —CH₂—OH, —CH₂—CH₂-0H, —CHOH—CH₃, —CH₂—SH, —CH₂—S—S—CH₂—CH(NH₂)COOH, —CH₂—CH₂—S—CH₃, —CH₂—CH₂—CONH₂, —CH₂—CONH₂, CH₂—CH₂—COOH, CH₂—COOH, —CH₂—CH₂—CH₂—NH—CO—NH₂, —CH₂-phenyl, —CH₂-(4-hydroxyphenyl), —CH₂—CH₂—CH₂—CH₂—NH₂, —CH₂—CH₂—CH₂—NH₂, —CH₂—CH₂—CH₂—NH—C(NH)—NH₂, —CH₂-(4-imidazolyl) and —CH₂-(3-indolyl).

14. The process as claimed in claim 13, wherein R¹ and R² are selected from the group consisting of hydrogen, methyl, ethyl and vinyl.

15. The process as claimed in claim 14, wherein the aliphatic alcohol is employed in proportions of 10 wt % to 5000 wt % based on a mass of the epoxy-functional organosilicon compounds.

16. A free amino acid moiety-containing organosilicon compound producible by the process as claimed in claim 15.

17. A composition comprising the free amino acid moiety-containing organosilicon compound as claimed in claim 16 which is blended with not more than 15 weight percent of an emulsifier.

18. A composition comprising the free amino acid moiety-containing organosilicon compound as claimed in claim 16 wherein the composition is a cosmetic formulation for skincare and haircare, a polish for treatment and finishing of surfaces, for finishing of textiles and textile fibers or as a softener during or after a washing process.
